(19) United States
(12) Patent Application Publication
(10) Pub. No.: US 2026/0222972 A1
(43) Pub. Date: Jul. 30, 2026

(54) ENHANCED SYSTEM INFORMATION BLOCK ACQUISITION IN CELL-FREE MIMO DEPLOYMENTS

(71) Applicant: InterDigital Patent Holdings, Inc., Wilmington, DE (US)

(72) Inventors: Patrick Svedman, Stockholm (SE); Allan Tsai, Boonton, NJ (US); Kyle Jung-Lin Pan, Saint James, NY (US); Javier Lorca Hernando, Madrid (ES); Arman Shojaeifard, London (GB); Guodong Zhang, Woodbury, NY (US)

(21) Appl. No.: 19/141,953

(22) PCT Filed: Dec. 20, 2023
(86) PCT No.: PCT/US2023/085084

§ 371 Date: Jun. 20, 2025

Related U.S. Application Data
(60) Provisional application No. 63/434,130, filed on Dec. 21, 2022.

(51) Int. Cl. H04W 48/12

(52) U.S. Cl. CPC H04W 48/12

(57) ABSTRACT

Procedures, methods, architectures, apparatuses, systems, devices, and computer program products for enhanced system information block, SIB, acquisition in cell-free Multiple Input Multiple Output, MIMO, deployments are described. System information, SI, overhead in cell-free MIMO deployment based on legacy Synchronization Signal Blocks, SSBs, is addressed. Overhead caused by transmission of SI messages in these deployments may be reduced. Enhanced SIB1 message is proposed, in which a WTRU blindly detects the PCI used for SIB1 in a super cell, based on a PCI hypothesis set. A WTRU determines a PCI hypothesis set, e.g., based on previously received SI, the frequency band, the PCI of the detected SSB, etc. The WTRU blindly receives/decodes SIB1 PDCCH, using the PCI hypotheses. The WTRU receives SIB1 PDSCH based on PCI hypothesis used for successfully received SIB1 PDCCH.

### CROSS-REFERENCE TO RELATED APPLICATIONS

This application claims the benefit of U.S. Provisional Patent Application No. 63/434,130 filed 21 Dec. 2022, and which is incorporated herein by reference.

### BACKGROUND

The present disclosure is generally directed to the fields of communications, software and encoding, including, for example, to methods, architectures, apparatuses, systems related to enhanced system information block one (SIB1) acquisition in cell-free Multiple-Input Multiple-Output (MIMO) deployments.

### SUMMARY

System information (SI) overhead in cell-free MIMO deployment based on legacy synchronization signal blocks (SSBs) is addressed. Overhead caused by transmission of SI messages in these deployments may be reduced.

According to one aspect of the present disclosure, there are provided methods, implemented by a WTRU, according to the described embodiments and appended claims.

According to a further aspect of the present disclosure, embodiments of WTRU, are described and are claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustration of points in the context of transmission reception point(s) (TRP(s)) and/or reception point(s) (RP(s));

FIG. 3 is an example cell with two TRPs and four SSBs;

FIG. 4 shows SSBs and Physical downlink control channel/physical downlink shared channel (PDCCH/PDSCH) for SIB1 acquisition in 5G New Radio (NR);

FIG. 5 is an embodiment of enhanced SIB1 transmission;

FIG. 6 is a flowchart of an embodiment of a WTRU procedure for enhanced acquisition of SIB1;

FIG. 7 is a flowchart of an embodiment of a WTRU procedure that includes determination of a physical cell identifier (PCI) hypothesis set, and the embodiment implements steps of FIG. 6;

FIG. 8 is a flowchart of yet another embodiment of a WTRU procedure that includes determination of a PCI hypothesis set, and that implements steps of FIG. 6;

FIG. 9 is a flowchart of an embodiment of a WTRU procedure for enhanced SI message reception;

FIG. 10 is an illustration of a combination of enhanced SIB1 reception and enhanced SI message reception; and

FIG. 11 is a master information block (MIB) contents table.

FIG. 12 is a flowchart of a method, implemented by a WTRU, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Abbreviations and Acronyms

| | |
|---|---|
| ARFCN | Absolute Radio-Frequency Channel Number |
| BWP | Bandwidth Part |
| CE | Control Channel Element |
| CORESET | Control Resource Set |
| CRAN | Centralized RAN |
| CSI-RS | Channel State Information RS |
| DCI | Downlink Control Information |
| DL | Downlink |
| DMRS | Demodulation RS |
| FDD | Frequency Division Duplex |
| FR | Frequency Range (e.g., FR1 or FR2) |
| GSCN | Global Synchronization Channel Number |
| IAB | Integrated Access and Backhaul |
| ID | Identity, also index |
| LSB | Least Significant Bit |
| MAC | Medium Access Control |
| MAC CE | MAC Control Element |
| MIB | Master Information Block |
| MIMO | Multiple Input Multiple Output |
| MSB | Most Significant Bit |
| MT | Mobile Termination |
| MU-MIMO | Multi-User MIMO |
| NTN | Non-terrestrial Network |
| PBCH | Physical Broadcast Channel |
| PCI | Physical Cell Id |
| PDCCH | Physical Downlink Control Channel |
| PDSCH | Physical Downlink Shared Channel |
| PUCCH | Physical Uplink Control Channel |
| PUSCH | Physical Uplink Shared Channel |
| QCL | Quasi Co-location |
| RAN | Radio Access Technology |
| REG | Resource Element Group |
| RP | reception point |
| RRC | Radio Resource Control |
| RS | Reference Signal |
| RSRP | RS Received Power |
| RX | Receiver |
| SCell | Secondary Cell |
| SFBC | Space-Frequency Block Coding |
| SFN | System Frame Number or Single Frequency Network |
| SI | System Information |
| SIB | System Information Block |
| SINR | Signal to Interference plus Noise power Ratio |
| SNR | Signal to Noise power Ratio |
| SRS | Sounding RS |
| SSB | Synchronization Signal/PBCH Block |
| STBC | Space-Time Block Coding |
| TDD | Time Division Duplex |
| TRP | Transmission and reception point |
| TRS | Tracking RS (also CSI-RS for tracking) |
| TRX | Transmitter and Receiver |
| UL | Uplink |

### Example Communications System

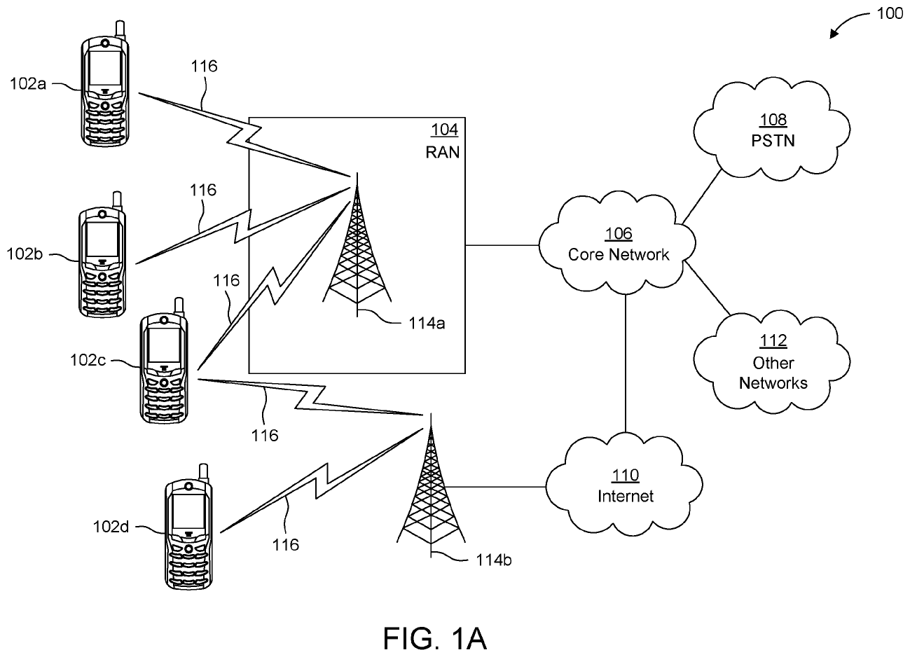

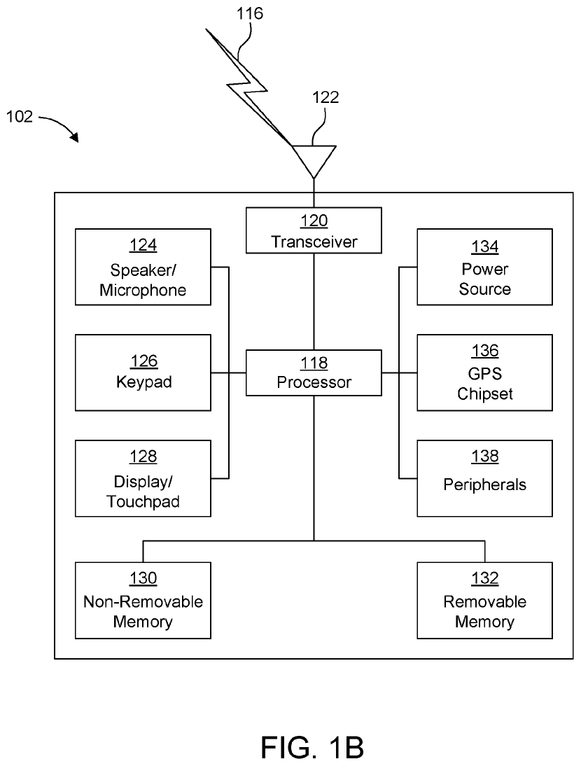

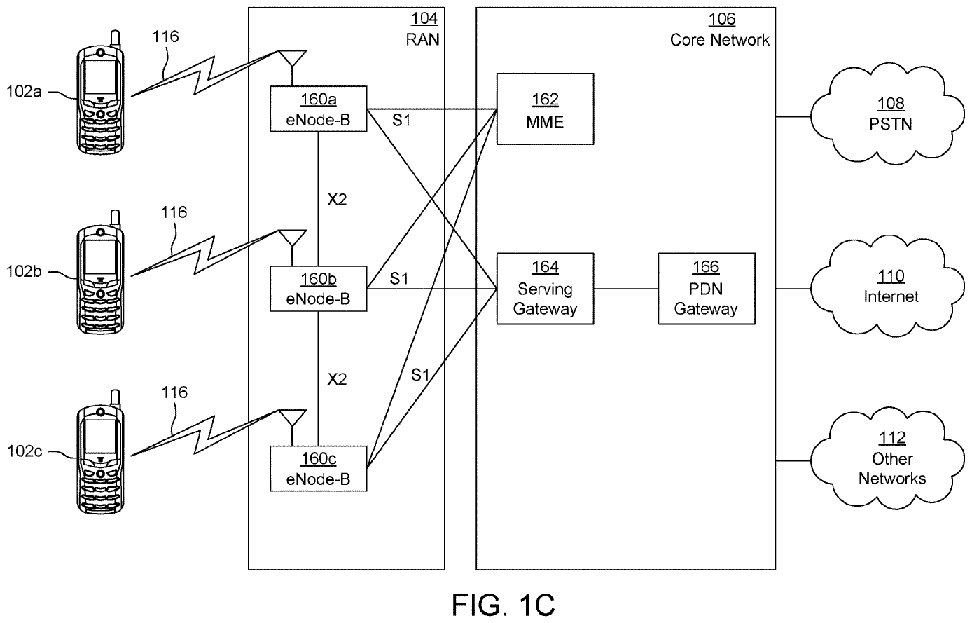

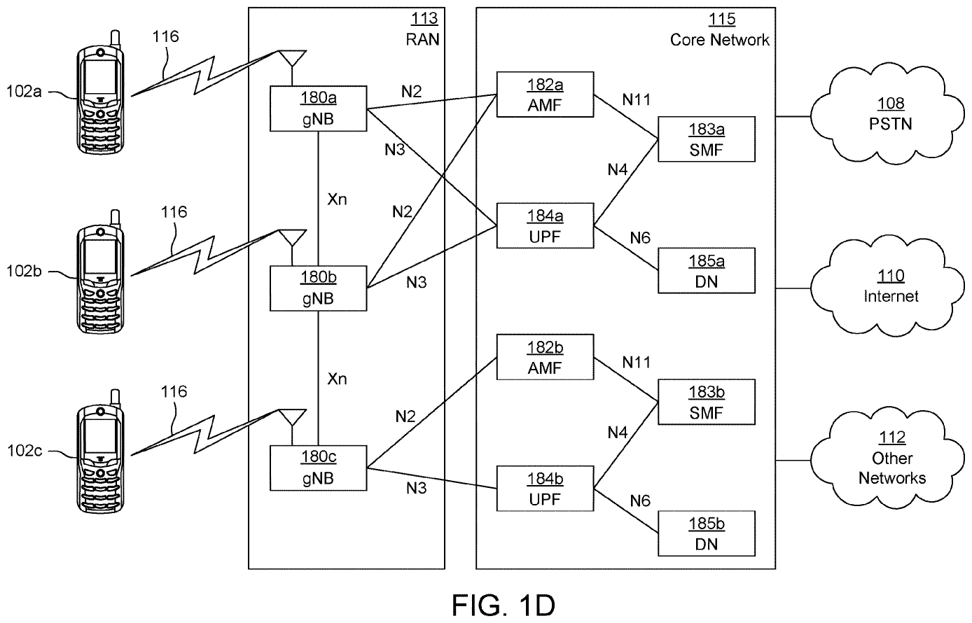

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Cell-Free MIMO Deployments: Introduction

Wireless communication between one or more WTRUs and a network is considered herein. The network, e.g., in the vicinity of a particular WTRU, may include transmission and reception points (TRPs). TRPs may be called “distributed antenna system” (DAS), “remote radio head” (RRH), “access point” (AP), or distributed MIMO in various contexts.

A TRP both transmits signals and/or channels to one or more WTRUs, usually called the downlink (DL), and receives signals and/or channels from one or more WTRUs, usually called the uplink (UL). In some cases, a TRP acts as a WTRU, e.g., when acting as a relay wherein the TRP may act as a WTRU and interact with another node to receive DL data which is then relayed to a WTRU, or wherein the TRP may act as a WTRU and relay UL data received from a WTRU to a base station.

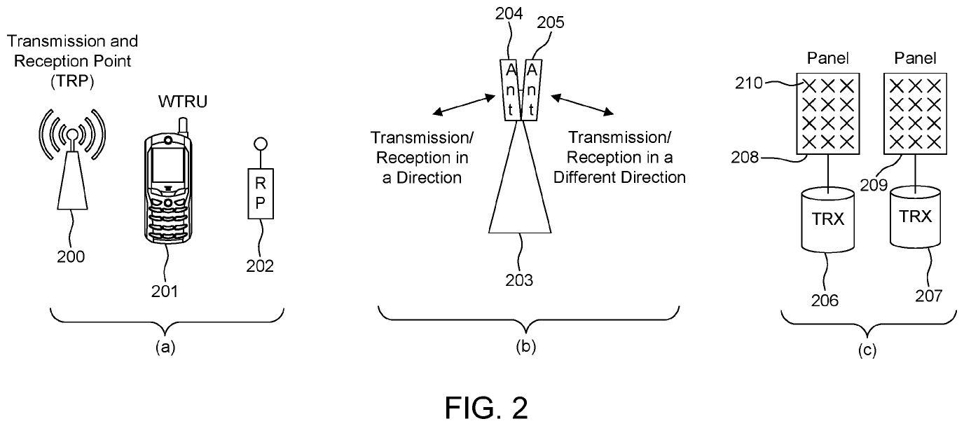

FIG. 2 is an illustration of ‘points’ in the context of transmission reception point(s) (TRP(s)) and/or reception point(s) (RP(s)). In FIG. 2(a), there are two geographically separated points in the vicinity of a WTRU 201, a TRP 200 and an RP 202. In FIG. 2(b), there are two TRPs, 204 and 205, in roughly the same geographical location in the form of two antennas (indicated by ‘Ant’ in the figure) mounted on a same site 203, but with main transmission/sensitivity directions (boresights) in significantly different directions. In FIG. 2(c), there are two panels, 208 and 209, each associated with a point, each comprising a rectangular array of cross-polarized antenna elements 210 (represented by ‘X’s in the figure). Each panel 208, 209, is connected to a different transmitter and receiver (TRX) chain 206 and 207 in this illustration.

In the context of (T) RPs, different points may be geographically separated, see FIG. 2(a), where TRP 200 and RP 202 are illustrated as being geographically separated. In some cases, different points may be located in approximately a same geographical location, but separated in some other way, for example the boresight(s) of the antenna(s) (or antenna element(s)) of a first point are significantly different from the boresight(s) of the antenna(s) of a second point.

An example of the latter is a cellular communication site serving multiple sectors in different directions, using different sets of antennas. In this case, the different sets of antennas serving different sectors in different directions from the site may be considered different points. This is illustrated in FIG. 2(b).

In some cases, antennas are arranged in one or more panels, where a panel for example comprises a rectangular panel with N×M antenna elements, as illustrated in FIG. 2(c), with panels 208 and 209 and antenna elements ‘X (210). In some cases, all or a subset of the antenna elements of a panel are connected to the same transmitter and receiver (TRX) chain or the same receiver (RX) chain. In some cases, antenna elements of different panels are connected to different transmitter and receiver (TRX) chains or different receiver (RX) chains. In some cases, different panels, which may or may not be geographically co-located, may correspond to different points. In other cases, different panels may correspond to the same point.

In some cases, a point may operate on multiple frequencies, for example two frequencies. However, in some cases, a site (including for example one antenna, an antenna array, a panel, a subset of antennas per frequency) in a geographic location with a particular transmission/reception direction on the multiple frequencies may count as multiple points, at least from the point of view of a WTRU. One reason may be that the radio signal propagation properties on the different frequencies are different. Another reason may be that the hardware at the network side results in signal transmission and/or reception differences on the different frequencies, for example different oscillators, calibration hardware for beam correspondence, phase shifters for beamforming etc.

A signal/channel received at a TRP may be subject to further processing, e.g., filtering, amplification, down-conversion, analog to digital (A/D) conversion (sampling), digitally signal processing, demodulation, channel decoding, etc. A signal/channel transmitted at a TRP may have been subject to various processing prior to transmission, e.g., filtering, amplification, peak-to-average power reduction, up-conversion, digital to analog (D/A) conversion, digital signal processing, modulation, channel encoding, etc. A subset (e.g., none, some or all) of these operations for reception/transmission may be performed at the TRP while other operations may be performed at one or more other location(s) connected with the TRP, e.g., through a fronthaul or backhaul link, e.g., by optical fiber, copper wire, over-the-air. In a centralized RAN (CRAN) implementation, signal processing for multiple points is performed at a centralized location.

### Cell-Free MIMO Deployments: Massively Distributed MIMO

A benefit of additional TRPs in a cell is a reduced average distance and pathloss between a WTRU and the nearest TRP, thereby allowing lower transmit power and hence lower interference in the system. Another benefit is improved spatial diversity, which means that there may be several candidate TRPs that may serve a WTRU. If the radio link to a serving TRP is blocked, the WTRU may instead be served by another TRP without a blocked radio link.

In a distributed MIMO system, the antennas might not be located at one or a few TRPs. Instead, the antennas are even more distributed throughout the wireless network. In some definitions, distributed MIMO also includes the case with a few TRPs, e.g., coherent joint transmission/reception involving a few TRPs.

A massively distributed MIMO system (also called distributed massive MIMO) combines the large number of antennas in a massive MIMO system with the distributed antennas in a distributed MIMO system. For example, the hundreds of antennas previously co-located at a massive MIMO TRP that covers a geographic area are distributed throughout the area. Subsets of antennas may be co-located at TRPs (sometimes called access points). The massively distributed MIMO deployment promises very high theoretical performance under ideal assumptions. However, there are numerous challenges to achieve those performance gains in practice, including fronthaul, synchronization, etc.

### Cell-Free MIMO Deployments: Cell-Free MIMO

Legacy cellular networks are based on the concept that a (typically) small number of TRPs transmit and receive signals corresponding to a cell in a frequency band. A frequency band in which multiple cells operate is sometimes called a frequency layer. It may be characterized by a range of frequencies, a center (e.g., carrier) frequency, a bandwidth, etc. Different cells on a frequency layer may use the same or different center frequencies and/or bandwidths.

The geographic area served by a cell is typically static. As a WTRU moves through the network, it may need to be handed over from cell to cell. Intra-frequency handovers, i.e., handovers between cells in the same frequency band, typically occur at cell edges, where quality-of-service is typically low.

The idea of cell-free operation is that instead of moving across more or less static cells, the cell serving a WTRU moves with the WTRU. From the WTRU's perspective, no, or at least much fewer, intra-frequency handovers are needed.

Another potential benefit of cell-free operation may be that deteriorating quality-of-service at the cell edge could be avoided. This may be realized by having a set of nearby TRPs serve a WTRU, rather than using a set of TRPs that need to be associated with the serving cell.

It may be attractive to use cell-free operation in a massively distributed MIMO deployment, which is sometimes called cell-free MIMO. The WTRU-centric “cell” can be operated by TRPs/antennas that are close to the WTRU, resulting in high and uniform quality-of-service.

### SS/PBCH Blocks (SSBs) in 5G NR

The SS/PBCH block (SSB) may be the signal/channel in 5G NR most associated with cell-based operation, e.g., since the physical cell id (PCI) is directly encoded into the various signals/channels included in an SSB. A WTRU that performs initial access detects, evaluates, and selects cells based on SSBs corresponding to different cells. Furthermore, while many signals/channels in 5G NR are WTRU specific, e.g., WTRU-specifically configured, SSBs are cell-specific, i.e., common and broadcasted to all WTRUs in a cell

An SSB comprises a primary synchronization signal (PSS), a secondary synchronization signal (SSS), a physical broadcast channel (PBCH), and a PBCH demodulation reference signal (DMRS).

There may be up to 4, 8, or 64 SSBs in a cell, depending on the frequency range of the cell. Lower frequencies support fewer SSBs while higher frequencies, e.g., millimeter wave, support up to 64 SSBs in a cell. Different SSBs may correspond to different SSB indices.

For various reasons, an SSB (with a certain SSB index) might not be transmitted on the nominal time-frequency resource assigned to the SSB. Hence, it may be more suitable to denote SSBs as candidate SSBs and to denote an SSB index as candidate SSB index. For brevity, the terms SSB and SSB index are used herein, but they may refer to candidate SSB and candidate SSB index, respectively.

### SS/PBCH Blocks (SSBs) in 5G NR: Physical Cell Id (PCI)

The physical cell Id (PCI) may be used to identify a cell on a carrier frequency. It is also used to generate various cell-specific signals/channels, for example PSS and SSS.

The NR PCI

$${N}_{I D}^{cell}$$

∈{0, 1, . . . , 1008} may be constructed from two other IDs,

$${N}_{I D}^{( 1 )} ∈ \{ 0 , 1 , … , 335 \} and {N}_{I D}^{( 2 )} ∈ \{ 0 , 1 , 2 \} {N}_{I D}^{cell} = 3 {N}_{I D}^{( 1 )} + {N}_{I D}^{( 2 )} .$$

### SS/PBCH Blocks (SSBs) in 5G NR: Primary Synchronization Signal (PSS)

The PSS may be used by a WTRU for example for cell search and coarse time- and frequency synchronization. The sequence used for PSS is based on

$${N}_{I D}^{( 2 )} .$$

### SS/PBCH Blocks (SSBs) in 5G NR: Secondary Synchronization Signal (SSS)

The SSS may be used by a WTRU for example for further synchronization, channel estimation, SSB-based measurements, e.g., reference signal received power (RSRP), and determining the PCI. The sequence used for SSS is based on both

$${N}_{ID}^{( 1 )} and {N}_{ID}^{( 2 )} .$$

### SS/PBCH Blocks (SSBs) in 5G NR: Physical Broadcast Channel Demodulation Reference Signal (PBCH DMRS)

The PBCH DMRS may be used by a WTRU for example for further synchronization, channel estimation, and SSB-based measurements, in addition to the SSS.

The PBCH DMRS sequence is based on the PCI, but also on the SSB index, or the least significant bits (LSB) thereof, and in some cases also the half-frame index. Hence, the WTRU may obtain some degree of sub-frame and frame timing upon reception of PBCH DMRS.

A sub-carrier offset is applied to the PBCH DMRS that depends on the PCI mod 4.

### SS/PBCH Blocks (SSBs) in 5G NR: Physical Broadcast Channel (PBCH)

The PBCH payload comprises the master information block (MIB) as well as timing-related information (8 bits) that is not included in the MIB. The timing-related information may include the most significant bits (MSB) of the SSB index and the half-frame index.

### SS/PBCH Blocks (SSBs) in 5G NR: MIB

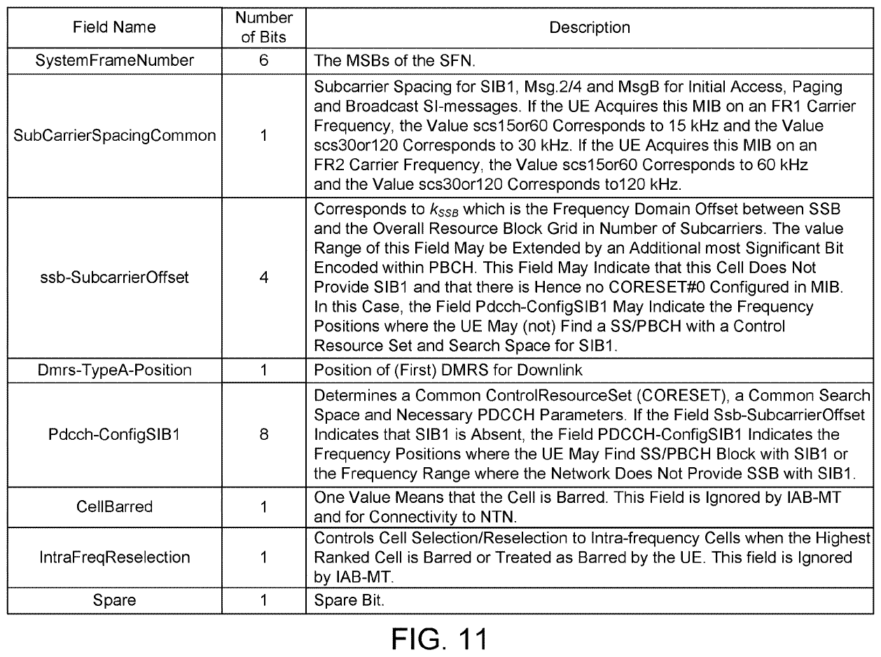

MIB contains information necessary to receive SIB1 as well as other information, as described in FIG. 11, which depicts a master information block (MIB) contents table.

Some cells might not support initial access and might not provide, i.e., transmit, SIB1. Some values of the subcarrier offset k_{SSB} may indicate that SIB1 is not broadcasted on the cell. If the WTRU cannot proceed with initial access on the cell, it doesn't need to know the subcarrier offset.

If the cell provides SIB1, the field pdcch-ConfigSIB1 corresponds to an IE with a 4-bit field (controlResourceSetZero) that determines a common CORESET with ID #0 and a 4-bit field (searchSpaceZero) that determines a common search space with ID #0.

If the cell does not provide SIB1, i.e., k_{SSB} is within a certain range, the value of k_{SSB} and pdcch-ConfigSIB1 may provide an indication of another global synchronization channel number (GSCN) that does provide SIB1.

### SIB1 in 5G NR

System information in 5G NR is divided into multiple parts, called system information blocks (SIBs). One or more SIBs may be carried in a PDSCH, which may be broadcasted in the cell. Different SIBs may correspond to different kinds of system information. A WTRU may choose to receive only a subset of the SIBs.

The SIB1 comprises various system information, e.g., how to perform random access to connect to the cell and scheduling information of other SIBs. During initial access, the WTRU receives SIB1 that is broadcasted in the cell. In other cases, such as handover or serving cell addition, contents of SIB1 may be conveyed using dedicated signaling. Here, the broadcasting of SIB1 that can be received by a WTRU in IDLE mode is described.

MIB and SIB1 may comprise the minimum system information.

### SIB1 in 5G NR: Scheduling and Transmission of SIB1

A cell that broadcasts SIB1 configures a CORESET #0 and search space #0 with the field pdcch-ConfigSIB1 in the MIB, which indicate where the WTRU can receive the PDCCH that schedules the PDSCH that carries SIB1. The slot and symbols in which the WTRU can receive and decode the PDCCH depends on the SSB index of the detected SSB. There is a one-to-one association between SSBs and disjoint sets of time multiplexed PDCCH monitoring occasions. The association implies that the WTRU may receive the PDCCH with the same time-frequency synchronization and spatial parameter (e.g., WTRU Rx beam) as was used to receive the SSB, i.e., the WTRU may assume that the PDCCH and PDSCH are quasi co-located (QCL) with the corresponding SSB. This provides support for SSB-based early beam management prior to system information acquisition.

The periodicity of a search space associated with an SSB is 2 radio frames or equal to the SSB periodicity, depending on the CORESET multiplexing pattern. Hence, a PDSCH carrying SIB1 is transmitted with the same periodicity.

The PDCCH and PDSCH for SIB1 are received within the initial DL bandwidth part (BWP), which spans the bandwidth of CORESET #0. The bandwidth is typically relatively low, which means that PDSCHs corresponding to different SSBs are typically multiplexed in time rather than in frequency. Furthermore, some TRPs might not be capable of simultaneously transmitting with multiple different SSB beams. Consequentially, due to the time multiplexing of both PDCCH and PDSCH for SIB1, the number of symbols and the overhead used for SIB1 transmission grows with the number of SSBs.

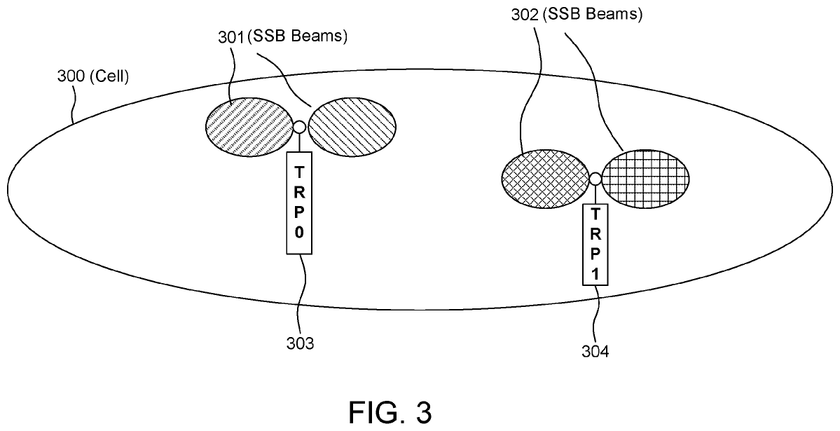

FIG. 3 shows an example cell 300 with two TRPs 303, 304, and two SSB beams 301, 302, per TRP. Hence, the number of SSBs in the cell is four. The different patterns in the SSB beams may correspond to different SSBs, e.g., different SSB indices.

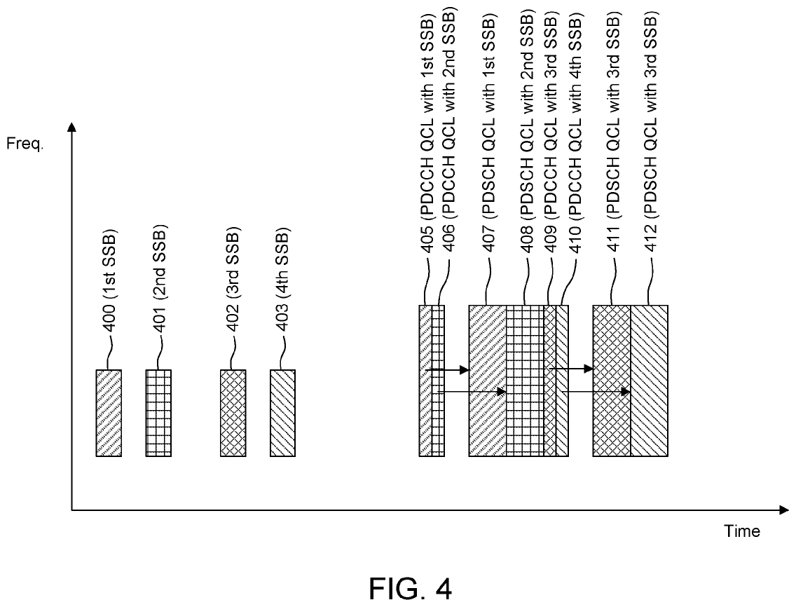

FIG. 4 illustrates the transmission of four SSBs 400, 401, 402, 403 in a cell, with corresponding CORESET/search spaces for reception of PDCCH 405, 406, 409, 410 that schedules PDSCH 407, 408, 411, 412 that carries SIB1, using CORESET multiplexing pattern 1. In this pattern, CORESET #0 may overlap in frequency with the SSB, at least partly. The four shown PDCCH monitoring occasions each correspond to a different SSB so that the WTRU may assume that the PDCCH (incl. its DMRS) is QCL with the corresponding SSB. The correspondence is shown by the pattern in the figure. PDCCH monitoring occasions 405, 406, 409, 410 correspond to SSBs 400, 401, 402, 403, respectively. The system information broadcast overhead grows with the number of SSBs in the cell. The arrows in the figure between a PDCCH and a corresponding PDSCH (e.g., between PDCCH 405 and PDSCH 407) may indicate that the PDSCH is scheduled by the PDCCH.

In CORESET multiplexing pattern 2, the PDCCH monitoring occasions for CORESET #0 occur just before the corresponding SSB and with the same periodicity. In CORESET multiplexing pattern 3, the PDCCH monitoring occasions for CORESET #0 occur simultaneously with the corresponding SSB and with the same periodicity. In pattern 2 and 3, the frequency resources for CORESET #0 do not overlap with the SSB.

### SIB1 in 5G NR: Content of SIB1

SIB1 typically contains a variety of cell configurations that are needed to access the cell.

SIB1 may contain various cell barring information, such as cell barred indication for NTN, cell barred indication for reduced capability WTRUs, and unified access control. In other words, various cell barring is indicated in both MIB and in SIB1.

SIB1 may indicate the scheduling information for the other SIBs, e.g., in the SI-SchedulingInfo information element (IE). Other SIBs are included in SI messages, where an SI message may include one or more SIBs. SIB1 may indicate that an SI message is broadcasted in the cell or not broadcasted. If an SI message is not broadcasted, a WTRU may request that it is.

An SI area may comprise a set of cells in which a SIB is valid. SIB1 may indicate an SI area ID and an indication per SIB (for other SIBs) if it is cell-specific or SI area specific. SIB1 may also indicate a SIB value tag, e.g., an integer between 0 and 31, that may be used to indicate that the corresponding SIB has been changed, for example like a version number.

### Other SIBs in 5G NR

The term other SIB may correspond to SIBs other than MIB and SIB1. In 5G NR Rel-17 for instance, SIBs up to SIB21 have been specified.

A WTRU may acquire a subset of the other SIBs, e.g., depending on its capabilities, needs, etc. The WTRU may for example acquire SI upon cell selection (e.g. upon power on), cell-reselection, return from out of coverage, after reconfiguration with sync completion, after entering the network from another radio access technology, upon receiving an indication that the system information has changed, upon receiving a public warning system (PWS) notification, upon receiving request (e.g., a positioning request) from upper layers; and whenever the WTRU does not have a valid version of a stored SIB or a valid version of a requested SIB.

A WTRU may store an acquired SIB and various parameters associated with the SIB. If the stored SIB is still valid for the cell, the WTRU might not need to re-acquire the SIB.

For example, if the stored SIB is associated with a cell, e.g., it was received in the cell, and with the same stored SIB value tag as the SIB value tag included in the latest SIB scheduling info (e.g., in SI-SchedulingInfo IE) received from the cell, the stored SIB is still valid for the cell.

In another example, a WTRU first acquires a SIB in a first cell with a first SI tracking area ID and with a first SIB value tag, and the WTRU stores the acquired SIB and the associated parameters. The stored SIB may be valid in a second cell if the latest SIB scheduling info (e.g., in SI-SchedulingInfo IE) received from the second cell includes the same SI tracking area ID as associated with the stored SIB, and the same SIB value tag as associated with the stored SIB.

The search space set for monitoring PDCCH that schedules PDSCH carrying an SI message (e.g., a Type0A-PDCCH common search space set) may be the same as or different than the search space set for monitoring PDCCH that schedules PDSCH carrying SIB1 (e.g., a Type0-PDCCH common search space set). The search space set for receiving an SI message may be configured in SIB1, using the searchSpaceOtherSystemInformation parameter. A WTRU may monitor PDCCH for receiving an SI message in an SI window, which has a configurable duration, for the SI message.

### Overview

Cell-free MIMO deployments are an attractive alternative to legacy cell-based (cellular) networks. The overhead and potential disruptions associated with handling cells can be reduced while the benefits of multi-TRP based operation can be retained.

Two aspect of legacy systems that are fundamentally linked to cells is cell search and system information acquisition. In 5G NR, for example, cell search is based on SSBs, where different SSBs may be transmitted from different TRPs or with different Tx beams from a TRP. System information delivery is also connected to SSBs, since system information transmissions are repeated per SSB.

In existing 5G NR specifications, there can be up to 4 or 8 SSBs in FR1, and up to 64 SSBs in FR2. Different SSBs in a cell are time multiplexed. One reason is that this allows base stations to be implemented using analog beamforming, in which a single Tx beam can be used at a time. Another reason is that this allows all available base station transmit power to be assigned to one SSB, thereby maximizing SSB coverage. SSBs are fundamental signals for various aspects of 5G NR, not only time-frequency synchronization, but also beam management, mobility measurements, etc. In systems with multiple TRPs and/or TRPs with hybrid/digital beamforming, time multiplexing of SSBs might not be necessary.

In future cell-free MIMO deployments, the number of TRPs and beams may need to increase dramatically. Therefore, a much higher number of SSBs (or equivalent system information acquisitions and cell-search) may be required. The increased number of SSBs may result in an increased overhead from system information transmissions. Hence, the problems that are explored herein include how to reduce the overhead from system information transmissions, in particular SIB1, when the number of SSBs is increased. These, and other subjects, are handled in what follows.

### Enhanced Acquisition of SIB1

Enhanced acquisition of SIB1 is considered. Since SIB1 PDCCH reception is configured in PBCH, there is little room for additional configuration. Instead, a set of PCI hypotheses for receiving/decoding the SIB1 PDCCH is introduced. A PCI hypothesis used when successfully receiving a SIB1 PDCCH may be used for SIB1 PDSCH reception, and even subsequent SI message reception.

Embodiments including enhanced SIB1 message is proposed, in which a WTRU blindly detects the PCI used for SIB1 in a super cell, based on a PCI hypothesis set. In a super cell, SSBs with different PCIs are used. The set of PCIs used for SSBs in a super cell may be denoted P.

A goal of this enhancement is to support reduced transmission of SIB1 from TRPs in the super cell compared to the per PCI and per SSB transmission of the SIB1 in the state-of-the-art. This may be achieved by the following enhancement. According to an embodiment, a WTRU that detected an SSB with a first PCI may determine that it may receive SIB1 using a second PCI.

Upon detecting an SSB, a WTRU may proceed to acquire SIB1, if the PBCH in the SSB indicates that SIB1 PDCCH is present. In state-of-the-art systems, the WTRU receives the SIB1 PDCCH and PDSCH using the PCI of the detected SSB.

For reduced overhead SIB1 delivery, it would be beneficial if a joint SIB1 for multiple PCIs in P could be transmitted. In state-of-the-art systems, the PDCCH and corresponding PDSCH carrying SIB1 may be received using the PCI of the detected SSB. Receiving a PDCCH with a PCI may comprise using the PCI, e.g., as parameter N_{ID}^{cell}, in PDCCH DMRS sequence generation, interleaved CCE-to-REG mapping (e.g., shift index parameter), and PDCCH scrambling. Receiving a PDSCH with a PCI may comprise using the PCI, e.g., as parameter N_{ID}^{cell}, in PDSCH DMRS sequence generation, and PDSCH scrambling.

According to an embodiment, joint SIB1 transmission by TRPs/beams that transmit SSBs with different PCIs in a super cell may be achieved if a different PCI can be used for an SSB and a SIB1 transmitted from the same TRP/beam. Hence, a WTRU that has detected an SSB needs to determine if it is to use the detected PCI for receiving the SIB1 or to use another PCI.

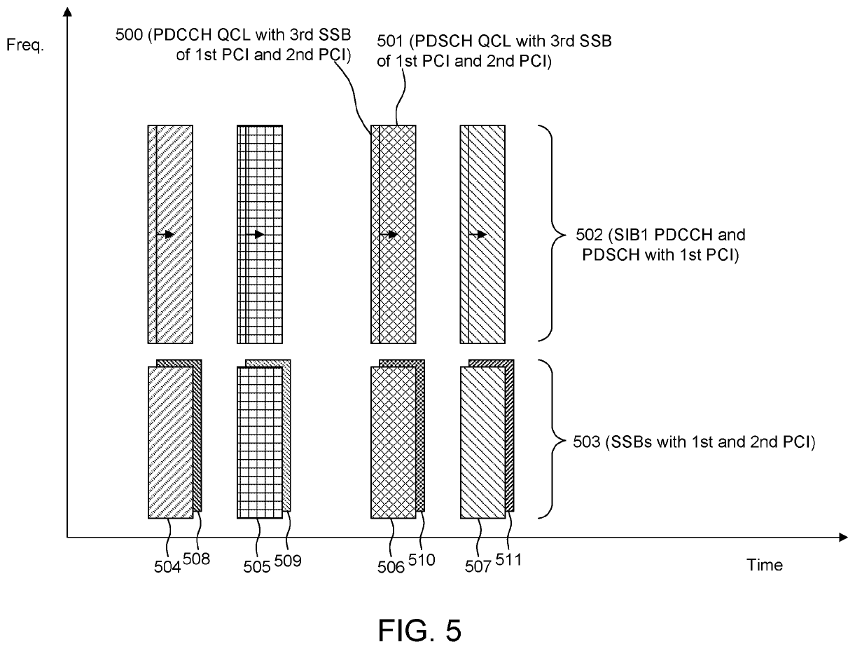

FIG. 5 shows an exemplary illustration of an embodiment of enhanced SIB1 transmission (502) in a super cell. Four SSBs 504, 505, 506, 507 with a first PCI and four SSBs 508, 509, 510, 511 with a second PCI are transmitted (elements 503). In this example embodiment, the SSBs with different PCIs in the super cell are overlapping; SSB 508 having the second PCI overlaps with SSB 504 having the first PCI, SSB 509 having the second PCI overlaps with SSB 505 having the first PCI, SSB 510 having the second PCI overlaps with SSB 506 having the first PCI, and SSB 511 having the second PCI overlaps with SSB 507 having the first PCI. In other example embodiments they may be non-overlapping. A WTRU that has detected an SSB with the 1st PCI (e.g., one of 504, 505, 506, 507) may receive SIB1 PDCCH and PDSCH using the 1st PCI (502). A WTRU that has detected an SSB with the 2nd PCI may also receive SIB1 PDCCH and PDSCH using the 1st PCI (502). This allows a single SIB1 to be transmitted (e.g., per SSB index), e.g., using joint transmission using the SSB beams used for the 1st and 2nd PCI. The WTRU may still use the detected SSB as QCL source for receiving SIB1. It is to be noted that in certain representative embodiments, joint transmission by multiple TRPs may correspond to a single frequency network (SFN) transmission, such as where the TRPs transmit a same signal and/or channel. In some embodiments, joint transmission by multiple TRPs may correspond to transmission of different signals and/or channels on overlapping time-frequency resources, such as by using different antenna ports associated with PDSCH transmission. The arrows in the figure between a PDCCH and a corresponding PDSCH (e.g., between PDCCH 500 and PDSCH 501) may indicate that the PDSCH is scheduled by the PDCCH. As in FIG. 4, a PDCCH monitoring occasion correspondence to an SSB, e.g., an SSB index, is illustrated by using the same pattern in the PDCCH monitoring occasion as in the corresponding SSB (index). A PDCCH monitoring occasion correspond to an SSB (with an index) with the 1^{st} PCI and to an SSB (with the same index) with the 2^{nd} PCI. SSBs with the 1^{st} PCI are illustrated with patterns with white background, while SSBs with the 2^{nd} PCI are illustrated with patterns with grey background.

### Enhanced Acquisition of SIB1: SIB1 PDCCH Reception Using PCI Hypothesis Set

According to some embodiments, a WTRU may receive and decode a PDCCH (for SIB1 reception) using multiple PCI hypotheses, e.g., blind decoding with different hypotheses. For example, a WTRU may receive (which may include decode) the PDCCH assuming that the PCI is the detected PCI (PCI of detected SSB) and receive (incl. decode) the PDCCH assuming that the PCI is a PCI different from the detected PCI. The different PCI hypotheses may require the WTRU to perform different PDCCH DMRS sequence generations (and corresponding channel estimations), different CCE-to-REG mapping de-interleaving, and different PDCCH descrambling. Since PDCCH DMRS sequence generation is an operation early in the PDCCH reception procedure, the PDCCH reception and decoding may need to be largely repeated for each PCI hypothesis.

According to some embodiments, multiple PCI that are different from the PCI of the detected SSB are blindly decoded. A set of PCIs are WTRU may use in blind decoding of PDCCH for SIB1 may be called a PCI hypothesis set.

Upon successfully receiving (incl. decoding) the PDCCH (and corresponding DCI) using a PCI hypothesis, the WTRU may proceed to receive the corresponding scheduled PDSCH using the PCI hypothesis used for the successful PDCCH reception.

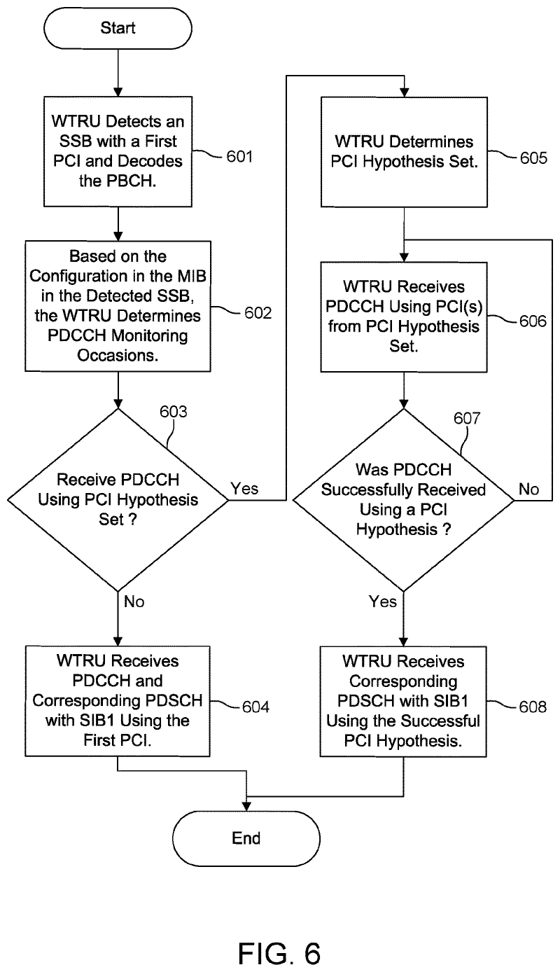

An exemplary embodiment of a WTRU procedure for enhanced acquisition of SIB1 is shown in FIG. 6. In step 601, the WTRU may detect an SSB with a first PCI and may decode the corresponding PBCH, which may include the MIB, as in legacy procedures. In the example illustrated in FIG. 5, the WTRU may detect for example SSB 510. In step 602, the WTRU may determine that SIB1 PDCCH is present and may determine PDCCH monitoring occasions, e.g., from the pdcch-ConfigSIB1 parameter in the MIB (see FIG. 11). In the example illustrated in FIG. 5, the WTRU may determine a PDCCH monitoring occasion 500, which corresponds to the detected SSB 510. In step 603, the WTRU determines if the PDCCH is to be received using PCI hypotheses from a PCI hypothesis set. If not, the WTRU proceeds to step 604, and receives PDCCH and corresponding PDSCH carrying SIB1 using the first PCI, e.g., according to legacy procedures. If so, the WTRU proceeds to step 605 and determines the PCI hypothesis set. The PCI hypothesis set may comprise one or more PCIs. In the example illustrated in FIG. 5, the WTRU may determine a PCI hypothesis set comprising the 1^{st} PCI and the 2^{nd} PCI. Further details of set determination are discussed below.

In step 606, the WTRU receives PDCCH using PCIs from the PCI hypothesis set. The PDCCH reception may be based on received baseband signal(s) stored in a buffer, where the signal(s) may include the time-frequency resources of a PDCCH monitoring occasion. The PDCCH reception using PCIs from the PCI hypothesis set may comprise performing receiver processing sequentially using PCIs in the PCI hypothesis set, e.g., based on the received signal in the buffer. The PDCCH reception using PCIs from the PCI hypothesis set may comprise performing receiver processing in parallel using multiple PCIs in the PCI hypothesis set, e.g., based on the received signal in the buffer. In some embodiments, a combination of sequential and parallel processing of hypotheses is done. If a PDCCH reception based on a PCI hypothesis results in successful PDCCH decoding, remaining processing, e.g., remaining PCI hypotheses, may be cancelled. Beside the PCI hypotheses, the WTRU may assume in the PDCCH reception that the PDCCH is QCL with the detected SSB (with the first PCI).

In step 607, the WTRU determines if a PDCCH was successfully decoded, using one of the PCI hypotheses. If not, the WTRU may return to step 606 to receive a PDCCH, e.g., in a subsequent PDCCH monitoring occasion. If, on the other hand, a PDCCH was successfully decoded, the WTRU may proceed to step 608.

In step 608, the WTRU receives the PDSCH that carries SIB1, as scheduled by the successfully decoded PDCCH. The WTRU may use the successful PCI hypothesis for receiving the PDSCH. The WTRU may assume in the PDSCH reception that the PDSCH is QCL with the detected SSB (with the first PCI).

### Enhanced Acquisition of SIB1: Determination of the PCI Hypothesis Set

Embodiments described in this section implement step 603 and/or 605 of FIG. 6.

According to some embodiments, the WTRU knows before SSB detection on a frequency that SIB1 PDCCH may be received using a PCI hypothesis set. For example, according to an embodiment, it may be specified that SIB1 PDCCH reception using a PCI hypothesis set may be used in a certain frequency band. Various details, such as X, Y, sub-range (see below), regarding the PCI hypothesis set may be specified per frequency band or frequency range. According to another embodiment, a WTRU may receive a configuration that indicates that SIB1 PDCCH reception using a PCI hypothesis set may be used in a certain frequency band, which may include various details such as X or Y (see below). According to an embodiment, the configuration may for instance be a part of a SIB, which may be received in another frequency band, dedicated RRC configuration obtained in CONNECTED mode, or other higher layer control signaling, e.g., from the core network. In one embodiment, SIB1 reception using a PCI hypothesis set is used for a detected SSB if the SSB frequency falls on a certain frequency raster, e.g., a synchronization frequency raster, which may be an enhanced synchronization frequency raster. In another embodiment, SIB1 reception using a PCI hypothesis set is used for a detected SSB if the SSB frequency does not fall on a certain frequency raster (with some margin), e.g., a legacy synchronization frequency raster (e.g., as defined by GSCN).

In some embodiments, a WTRU may determine from the SSB if the SIB1 PDCCH reception using a PCI hypothesis set may be used. For example, the PBCH in the SSB may indicate this, explicitly or implicitly.

In some embodiments, the PBCH payload or MIB may indicate that SIB1 PDCCH reception using a PCI hypothesis set may be used. For example, the spare bit in the legacy MIB may be repurposed to indicate to enhanced WTRUs that SIB1 PDCCH reception using a PCI hypothesis set may be used.

The full range of PCIs, e.g., from 0 to 1007, or a part of the range (sub-range) of PCIs, e.g., from 504 to 1007, may be divided into PCI groups. The division and/or sub-range may be specified, configured, based on the frequency band, etc. For example, a PCI group may comprise a set of X consecutive PCIs. The number of applicable PCI groups may be the number of PCIs divided by X. For instance, for 1008 PCIs and X=4, the number of PCI groups may be Z=1008/4=252, e.g., {0, 1, 2, 3}, {4, 5, 6, 7}, . . . , {1004, 1005, 1006, 1007}. The exemplary PCI group definition with 4 consecutive PCIs may be beneficial since it may be advantageously used in a super cell with PCI set P equal to a PCI group. Overlapping SSBs with PCIs in P will have different PBCH DMRS sub-carrier shifts, since the sub-carrier shift is based on PCI modulo 4 in 5G NR.

In another embodiment, a PCI group may comprise a set of X PCIs that are spaced Y PCIs apart, e.g., a set of four PCIs spaced Y=252 PCIs apart such as {0, 252, 504, 756}, {1, 253, 505, 757}, etc.

In some embodiments, the WTRU may determine the PCI hypothesis set from the detected PCI. The PCI hypothesis set may be based on the PCI group that contains the detected PCI. For example, the PCI hypothesis set may be equal to the PCI group that contains the detected PCI. In another embodiment, the PCI hypothesis set may be a subset of the PCI group that contains the detected PCI. For example, the PCI hypothesis set may comprise the lowest (or highest) PCI in the PCI group. In another embodiment, the PCI hypothesis set may comprise the lowest (or highest) PCI in the PCI group and the detected PCI.

Note that even though the WTRU may use a different PCI for receiving SIB1 PDCCH and PDSCH, the WTRU may still use the detected SSB with the first PCI as the QCL source for SIB1 PDCCH and PDSCH reception. In some embodiments, the WTRU may use SSBs with PCIs from the determined PCI group as QCL sources.

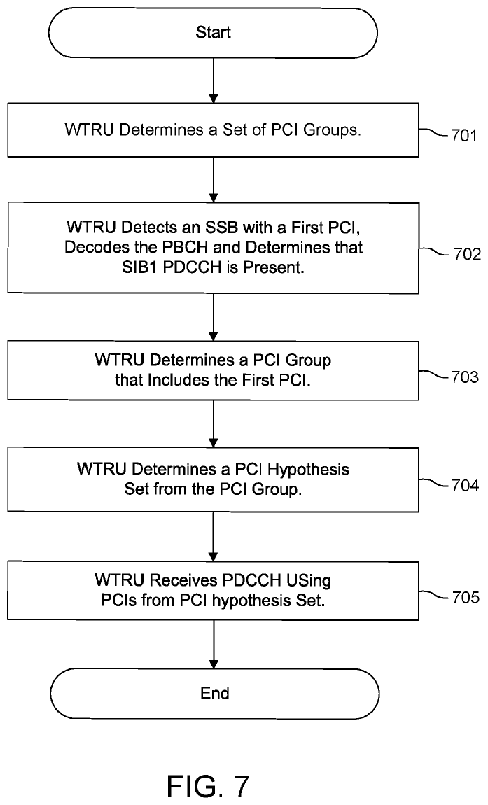

An embodiment of a WTRU procedure including determination of a physical cell identifier (PCI) hypothesis set is shown in FIG. 7, that implements some steps of FIG. 6; for example, step 702 corresponds to step 601-602. 703-704 may correspond to 605. 705 may correspond to 606-607.

In step 701, the WTRU determines a set of PCI groups, for example by dividing a PCI range into PCI groups, e.g., as described above. The PCI groups may be disjoint. The PCI groups may be of equal or unequal size. In step 702, the WTRU detects an SSB with a first PCI, decodes the corresponding PBCH, and determines that a SIB1 PDCCH is present, e.g., that a CORESET for Type0-PDCCH common search space set is present. In step 703, the WTRU determines which PCI group from the set of PCI groups that includes the first PCI. Based on the determined PCI group, and potentially also based on the first PCI, in step 704, the WTRU determines the PCI hypothesis set, e.g., as described above. In step 705, the WTRU receives PDCCH based on the determined PCI hypothesis set.

In a numerical example, the range of PCIs are as the full range in 5G NR, i.e., from 0 to 1007, and the PCI group size X=4. The 252 PCI groups are {0, 1, 2, 3}, {4, 5, 6, 7}, . . . , {1004, 1005, 1006, 1007}. Now, assume that the WTRU detects an SSB with PCI=6 (the first PCI). The WTRU may determine that the second PCI group {4, 5, 6, 7} includes PCI-6. In this example, the WTRU determines the PCI hypothesis set to include the lowest PCI in the PCI group and the first PCI. In other words, the WTRU determines the PCI hypothesis set as {4, 6}. The first PCI in the set (4) may correspond to enhanced operation. For example, the super cell may include PCIs from 4, 5, 6, 7, for example, P={4, 5, 6}. With this enhancement, the super cell may transmit SIB1 using PCI=4 only. WTRUs that detect an SSB with PCI=5 or PCI=6 will use PCI=4 as a PCI hypothesis when receiving SIB1 PDCCH, in addition to the PCI of the detected SSB. On the other hand, PCI=7 might not be included in the super cell but may be used in a legacy cell. A WTRU that detects and SSB with PCI=7 will include PCI-7 in the PCI hypothesis set and may successfully receive a SIB1 using that hypothesis. Hence, with the method described here, efficient SIB1 delivery and acquisition may be achieved in a network with mixed super cells and legacy cells.

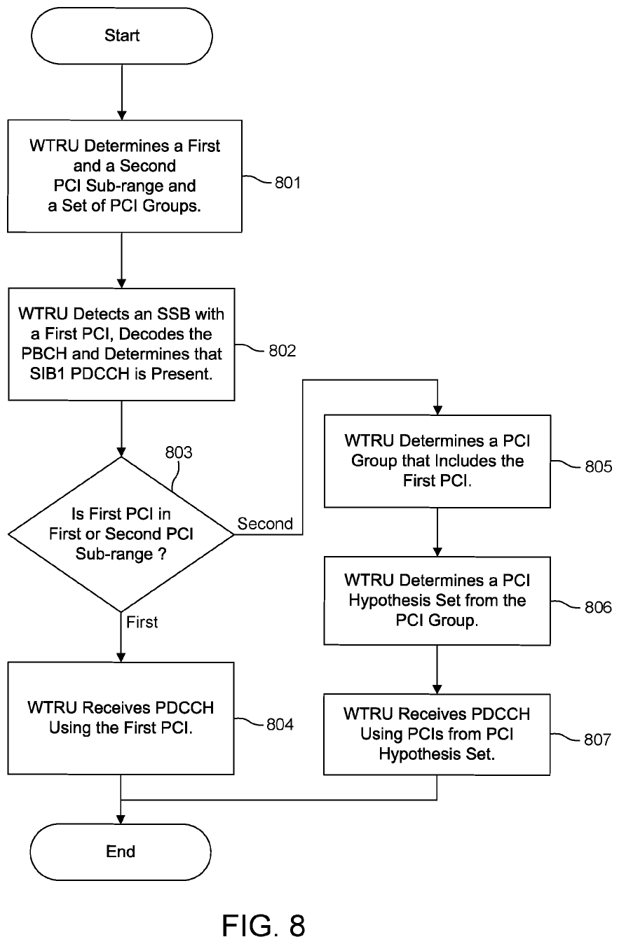

Another embodiment of a WTRU procedure that includes determination of a physical cell identifier (PCI) hypothesis set is shown in FIG. 8, that implements some steps of FIG. 6; for example, step 802 may correspond to step 601-602. Step 803 may correspond to 603. Steps 805-806 may correspond to step 605. Step 807 may correspond to steps 606-607.

In 801, the WTRU determines a first and second sub-range of PCIs, where the union of the ranges may cover the full range of PCIs. A set of PCI groups is determined, e.g., for the second sub-range or the full range. Step 802 is as step 702 in FIG. 7. In 803, the WTRU determines if the first PCI falls into the first PCI sub-range or the second PCI sub-range. The first PCI being in the first PCI sub-range indicates that the WTRU may proceed to step 804 and receive the PDCCH using the first PCI. The first PCI being in the second PCI sub-range indicates that the WTRU may proceed to 805-807 and receive the PDCCH using PCIs from a PCI hypothesis set. Steps 805-807 is as steps 703-705 in FIG. 7.

### Enhanced Acquisition of SIB1: SIB1 PDCCH Reception Using Single PCI Hypothesis

In some embodiments, SIB1 PDCCH may be received with a single PCI hypothesis, i.e., the PCI hypothesis set may comprise a single PCI. If there is a single hypothesis, this may be seen as not being a hypothesis. Still, the various methods described for the PCI hypothesis set above may be applicable, but with the set comprising one PCI.

A WTRU may determine a set of PCI groups for a full range of PCIs or a sub-range of PCIs, as described above. Based on the PCI of a detected SSB (the first PCI), the WTRU may determine a PCI group, e.g., a group including the detected PCI. Based on a rule, the WTRU may determine a second PCI from the PCI group, for example, the lowest or highest PCI in the group. Note that the second PCI may be equal to the first PCI, e.g., if the first PCI happens to be the lowest PCI in the PCI group. The WTRU may proceed to receive SIB1 PDCCH and PDSCH based on the second PCI.

By determining a single PCI for SIB1 PDCCH reception, the blind decoding complexity compared to legacy SIB1 PDCCH reception is maintained.

### Enhanced Acquisition of SIB1: SSB Groups for SIB1 Acquisition

Even with joint multi-TRP transmission of SIB1 PDCCH and PDSCH across PCIs in a super cell, SIB1 may still be repeated across SSBs. In some scenarios, it may be beneficial to jointly transmit SIB1 PDCCH and/or PDSCH for multiple SSBs as well, e.g., using SSBs groups as described in state-of-the-art, but with SIB1 instead of an SI message. SSB grouping for SIB1 may be more attractive for CORESET multiplexing pattern 1, where SIB1 PDCCH monitoring occasions is disconnected from the SSB transmission occasions, than for pattern 2 and 3. Note that the SSBs in an SSB group (with a PCI) may be transmitted from a TRP or from multiple TRPs, in various deployment scenarios.

A difference between SSB grouping for SIB1 and SSB grouping for SI messages may be that the SSB grouping for an SI message may configured in SIB1. SIB1 reception is largely configured in MIB and there is little room for additional configuration in MIB. However, it may be possible to use one bit in PBCH/MIB to indicate that SSB grouping is used. If so, the number of SIB1 PDCCH occasions may be reduced from the maximum number of SSBs K to the maximum number of SSBs divided by the SSB group size G, which may be fixed in a specification for this enhancement. The first SIB1 PDCCH monitoring occasion may correspond to the first SSB group, which may correspond to SSBs 0 to (G−1), the second SIB1 PDCCH monitoring occasion may correspond to SSBs G to (2G−1), etc. In some embodiments, the WTRU may assume that the detected SSB is QCL with the SIB1 PDCCH and PDSCH. In some embodiments, the WTRU may assume that all SSBs in the corresponding SSB group are QCL with the SIB1 PDCCH and PDSCH.

### Enhanced Acquisition of SIB1: Considerations on Legacy WTRU Operation

A legacy WTRU may be able to detect the SSBs in a super cell, and may use SSB-based measurements, e.g., if a cell with PCI in the super cell is configured as a non-PCell, e.g., SCell, for the legacy WTRU.

A legacy WTRU performing initial access and that detects an SSB with a PCI that is also used to transmit SIB1 in a super cell may acquire SIB1. However, a legacy WTRU performing initial access that detects an SSB with a PCI that is not used to transmit SIB1 may try to acquire SIB1 using the PCI of the detected SSB, since the SSB indicates that SIB1 PDCCH is present. As the legacy WTRU will fail to acquire SIB1, it will consider the cell (PCI) as barred.

Hence, initial access coverage may be spotty for legacy WTRUs. It would be preferable if legacy WTRU would use another frequency layer for their PCell, while they could use the super cell layer for an SCell. Therefore, it may be suitable to indicate the cells in the super cell as barred for legacy WTRUs, e.g., in MIB and/or SIB1, and potentially also avoid intra-frequency cell selection/re-selection on the frequency layer with the super cell(s), e.g., by setting intraFreqReselection in MIB as ‘notAllowed’.

Application to SI message Reception

A WTRU that detects an SSB with a first SSB may use a second PCI for successfully receiving SIB1, e.g., as disclosed above. In one embodiment to enhance also SI message reception, the WTRU may use the second PCI as an anchor PCI when receiving an SI message. It may be indicated in SIB1 if the WTRU may use the second PCI as an anchor PCI, or if it may use another PCI, e.g., the first PCI or a third PCI different from the first and second PCIs.

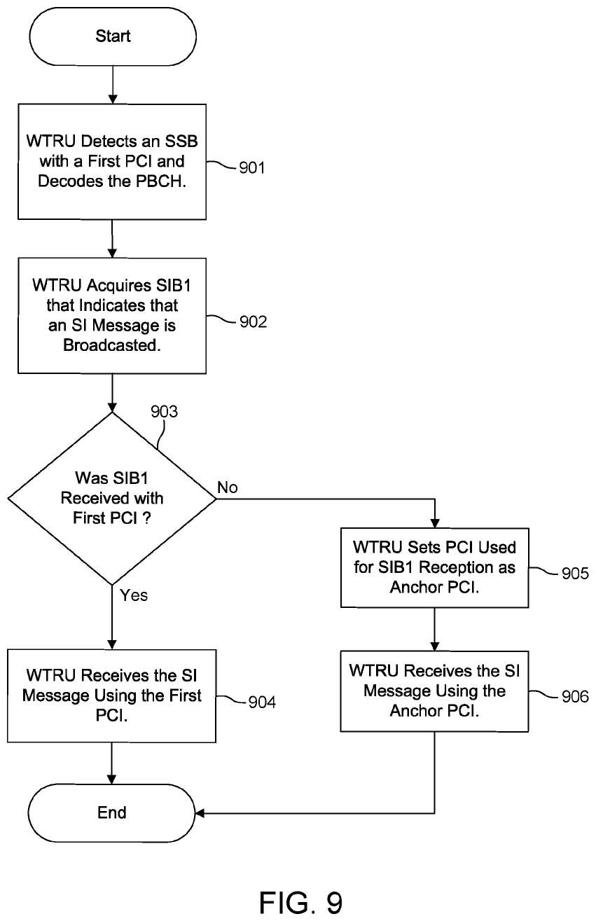

FIG. 9 is a flowchart of an embodiment of a WTRU procedure for enhanced SI message reception. Steps 901 and 902 may follow various procedures described herein. The SIB1 may have been successfully received using the first PCI or another PCI, e.g., based on a PCI hypothesis set. The acquired SIB1 may indicate that an SI message is broadcasted. In step 903, the WTRU determines if SIB1 was successfully received using the first PCI. If so, the WTRU may proceed to step 904 and receive the SI message using the first PCI, e.g., using legacy procedures. If not, in 905, the WTRU may set the PCI that was used to successfully receive SIB1 as an anchor PCI for the SI message reception. In step 906, the WTRU may successfully receive the SI message using the anchor PCI.

Receiving an SI message PDCCH with the anchor PCI may comprise using the anchor PCI, e.g., as parameter N_{ID}^{cell}, in PDCCH DMRS sequence generation, interleaved CCE-to-REG mapping (e.g., shift index parameter), PDCCH scrambling, etc. Receiving an SI message PDSCH with the anchor PCI may comprise using the anchor PCI, e.g., as parameter N_{ID}^{cell}, in PDSCH DMRS sequence generation, PDSCH scrambling, etc. Even though the WTRU receives the SI message using the anchor PCI, the WTRU may assume that SI message PDCCH and PDSCH is QCL with the detected SSB. In some embodiments, the WTRU may also assume that the SSB with the same index as the detected SSB but with the anchor PCI is a QCL source for the SI message PDCCH and PDSCH.

The determination of the second PCI, e.g., using PCI groups, may be rather inflexible, e.g., if the PCI group definition is specified, e.g., per frequency band. For example, a PCI group may be limited to a fixed number of PCIs, e.g., four PCIs. Hence, joint transmission of a SIB1 may be limited to the number of PCIs in a PCI group.

However, a super cell may use a larger number of PCIs than the number of PCIs in a PCI group. Therefore, duplicated SIB1 transmission from multiple PCI groups may be needed in such a super cell. For SI message transmission, however, an anchor PCI may be configured in SIB1. By configuring the same anchor PCI in the SIB1s corresponding to multiple PCI groups in a super cell, a greater level of joint transmission for an SI message may be achieved, e.g., joint transmission across all PCIs in P.

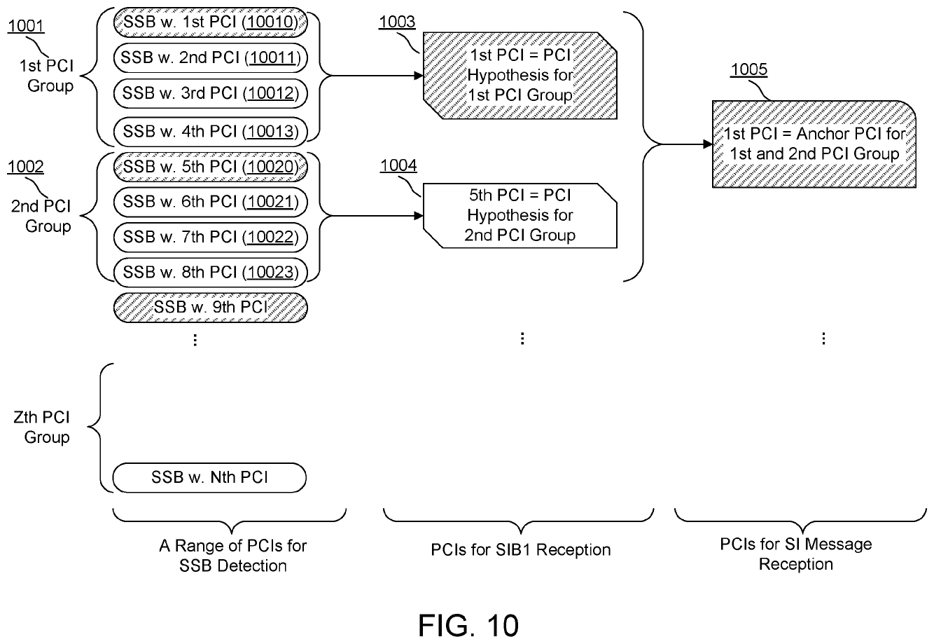

An exemplary illustration of a combination of enhanced SIB1 reception and enhanced SI message reception is shown in FIG. 10. Here, a range of N PCIs are considered, e.g., 1008 PCIs. The PCIs may be divided into Z groups with G=4 PCIs per group. In this example, a super cell uses a 1^{st} to an 8^{th} PCI, e.g., P may comprise {1^{st} PCI, 2^{nd} PCI, . . . , 8^{th} PCI (10023)}, which may correspond to two PCI groups, e.g. a first PCI group 1001 {1^{st} PCI (10010), . . . , 4^{th} PCI (10013)}, i.e., 10010-10013 and a second PCI group 1002 {5^{th} PCI (10020), . . . , 8^{th} PCI (10023)}, i.e., 10020-10023. Upon cell search, a WTRU may detect an SSB with any PCI, e.g., depending on where in the network the WTRU is located. For example, if the WTRU detects an SSB with the 6^{th} PCI (10021), the WTRU may determine that the 6^{th} PCI is in the 2^{nd} PCI group (1002). Hence, the WTRU may include (1004) a PCI from the 2^{nd} PCI group as a PCI hypothesis, e.g., the lowest PCI, which may be the 5^{th} PCI (10020) in this example. In some embodiments, the WTRU may add the detected PCI, which is the 6^{th} PCI (10021) in this example, to the PCI hypothesis set. For SIB1 PDCCH reception, the WTRU may try to receive SIB1 PDCCH using the PCI(s) in the PCI hypothesis set. Since the super cell uses PCIs in two PCI groups, the super cell may need to transmit two SIB1 PDCCH and two SIB1 PDSCH, e.g., for a certain SSB index, one with a PCI from a PCI hypothesis set for the 1^{st} PCI group (1003) and one with a PCI from a PCI hypothesis set for the 2^{nd} PCI group (1004). The SIB1 corresponding to the 1^{st} PCI group may indicate that the 1^{st} PCI may be used as an anchor PCI for SI message reception (1005). The SIB1 corresponding to the 2^{nd} PCI group may also indicate that the 1^{st} PCI may be used as an anchor PCI for SI message reception (1005). The SI message(s) in the super cell may be transmitted using the 1^{st} PCI. A WTRU in the super cell may use the 1^{st} PCI to receive an SI message, regardless of which of the 1^{st} or 2^{nd} PCI groups the PCI of the detected SSB belongs to.

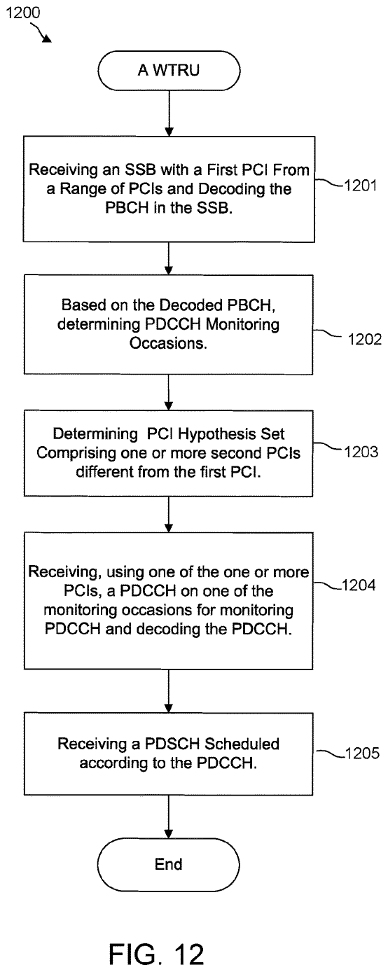

FIG. 12 is a method 1200, implemented by a WTRU, according to an embodiment.

The method comprises, in 1201, receiving a synchronization signal block (SSB) with a first physical cell identifier (PCI) from a range of PCIs and decoding a physical broadcast channel (PBCH) in the SSB;
the method comprises in 1202, determining, based on the decoded PBCH, monitoring occasions for monitoring a physical downlink control channel (PDCCH);
the method comprises in 1203, determining a PCI hypothesis set comprising one or more second PCIs different from the first PCI;
the method comprises in 1204, receiving, using one of the one or more second PCIs, a PDCCH on one of the monitoring occasions for monitoring PDCCH, and decoding the PDCCH; and
the method comprises in 1205, receiving a physical downlink shared channel (PDSCH) scheduled according to the PDCCH.

According to an embodiment of the method, the determining the PCI hypothesis set is based on a frequency band or a frequency range used by the WTRU.

According to an embodiment of the method, the determining the PCI hypothesis set is based on the first PCI.

According to an embodiment of the method, the range of PCIs is divided into disjoint PCI groups, and the WTRU determines the PCI hypothesis set as comprising a lowest or a highest PCI in the PCI group of one of the disjoint PCI groups that includes the first PCI.

According to an embodiment of the method, the WTRU determines the PCI hypothesis set as further comprising the first PCI.

According to an embodiment, the method comprises receiving configuration information indicating that system information block one (SIB1) PDCCH reception using a PCI hypothesis set is to be used in a first frequency band.

According to an embodiment, the method comprises receiving the configuration information in a system information block (SIB) received in a second frequency band different from the first frequency band.

According to an embodiment, the method comprises receiving the configuration information in a system information block (SIB) received via radio resource control (RRC) configuration.

According to an embodiment, the method comprises receiving the configuration information in a system information block (SIB) from a core network.

According to an embodiment, the method comprises determining that the PDCCH is to be received using PCI hypotheses from a PCI hypothesis set, based on an indication comprised in the PBCH in the SSB.

The present disclosure also discloses a wireless transmit-receive unit (WTRU), comprising at least one processor configured to:
receive a synchronization signal block (SSB) with a first physical cell identifier (PCI) from a range of PCIs and decode physical broadcast channel (PBCH) in the SSB;
determine, based on the decoded PBCH, monitoring occasions for monitoring a physical downlink control channel (PDCCH);
determine a PCI hypothesis set comprising one or more second PCIs different from the first PCI;
receive, using one of the one or more second PCIs, a PDCCH on one of the monitoring occasions for monitoring PDCCH, and decode the PDCCH; and
receive a physical downlink shared channel (PDSCH) scheduled according to the PDCCH.

According to an embodiment of the WTRU, the at least one processor is configured to determine the PCI hypothesis set based on a frequency band or a frequency range used by the WTRU.

According to an embodiment, the at least one processor is configured to determine the PCI hypothesis set based on the first PCI.

According to an embodiment, the range of PCIs is divided into disjoint PCI groups, and the at least one processor is configured to determine the PCI hypothesis set as comprising a lowest or a highest PCI in the PCI group of one of the disjoint PCI groups that includes the first PCI.

According to an embodiment, the at least one processor is configured to determine the PCI hypothesis set as further comprising the first PCI.

According to an embodiment, the at least one processor is configured to receive configuration information indicating that system information block one (SIB1) PDCCH reception using a PCI hypothesis set is to be used in a first frequency band.

According to an embodiment, the at least one processor is configured to receive the configuration information in a system information block (SIB) received in a second frequency band different from the first frequency band.

According to an embodiment, the at least one processor is configured to receive the configuration information in a system information block (SIB) received via radio resource control (RRC) configuration.

According to an embodiment, the at least one processor is configured to receive the configuration information in a system information block (SIB) from a core network.

According to an embodiment, the at least one processor is configured to determine that the PDCCH is to be received using PCI hypotheses from a PCI hypothesis set, based on an indication comprised in the PBCH in the SSB.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented by a wireless transmit-receive unit (WTRU), the method comprising:
receiving a synchronization signal block (SSB) with a first physical cell identifier (PCI) of a range of PCIs and decoding a physical broadcast channel (PBCH) in the SSB, wherein the range of PCIs is divided into disjoint PCI groups;
determining, based on the decoded PBCH, monitoring occasions for monitoring a physical downlink control channel (PDCCH) transmission;
determining a PCI hypothesis set comprising one or more second PCIs different from the first PCI, wherein the one or more second PCIs belong to a same PCI group of the disjoint PCI groups as the first PCI;
receiving, using one of the one or more second PCIs, a PDCCH transmission on one of the monitoring occasions; and
receiving a physical downlink shared channel (PDSCH) transmission scheduled according to the PDCCH transmission.

2. The method according to claim 1, wherein determining the PCI hypothesis set comprises determining the PCI hypothesis set based on a frequency band or a frequency range used by the WTRU.

3. The method according to claim 1, wherein determining the PCI hypothesis set comprises determining the PCI hypothesis set is based on the first PCI.

4. The method according to claim 3, wherein determining the PCI hypothesis set comprised determining the PCI hypothesis set as comprising a lowest or a highest PCI in the PCI group of one of the disjoint PCI groups that includes the first PCI.

5. The method according to claim 4, wherein determining the PCI hypothesis set comprises determining the PCI hypothesis set as further comprising the first PCI.

6. The method according to claim 1, comprising receiving configuration information indicating that, in a first frequency band, a PDCCH transmission scheduling a PDSCH transmission carrying a system information block (SIB) is to be received using a PCI hypothesis set.

7. The method according to claim 6, wherein the configuration information is received in a SIB in a second frequency band different from the first frequency band.

8. The method according to claim 6, wherein the configuration information is received in a SIB via a radio resource control (RRC) configuration.

9. The method according to claim 6, wherein the configuration information is received in a SIB from a core network.

10. The method according to claim 1, comprising determining that the PDCCH transmission is to be received using PCI hypotheses from a PCI hypothesis set, based on an indication comprised in the PBCH in the SSB.

11. A wireless transmit-receive unit (WTRU), comprising at least one processor, configured to:
receive a synchronization signal block (SSB) with a first physical cell identifier (PCI) of a range of PCIs and decode a physical broadcast channel (PBCH) in the SSB, wherein the range of PCIs is divided into disjoint PCI groups;
determine, based on the decoded PBCH, monitoring occasions for monitoring a physical downlink control channel (PDCCH) transmission;
determine a PCI hypothesis set comprising one or more second PCIs different from the first PCI, wherein the one or more second PCIs belong to a same PCI group of the disjoint PCI groups as the first PCI;
receive, using one of the one or more second PCIs, a PDCCH transmission on one of the monitoring occasions; and
receive a physical downlink shared channel (PDSCH) transmission scheduled according to the PDCCH transmission.

12. The WTRU according to claim 11, wherein the at least one processor is configured to determine the PCI hypothesis set based on a frequency band or a frequency range used by the WTRU.

13. The WTRU according to claim 11, wherein the at least one processor is configured to determine the PCI hypothesis set based on the first PCI.

14. The WTRU according to claim 13, wherein the at least one processor is configured to determine the PCI hypothesis set as comprising a lowest or a highest PCI in the PCI group of one of the disjoint PCI groups that includes the first PCI.

15. The WTRU according to claim 14, wherein the at least one processor is configured to determine the PCI hypothesis set as further comprising the first PCI.

16. The WTRU according to claim 11, wherein the at least one processor is configured to receive configuration information indicating that, in a first frequency band, a PDCCH transmission scheduling a PDSCH transmission carrying a system information block (SIB) is to be received using a PCI hypothesis set.

17. The WTRU according to claim 16, wherein the at least one processor is configured to receive the configuration information in a SIB in a second frequency band different from the first frequency band.

18. The WTRU according to claim 16, wherein the at least one processor is configured to receive the configuration information in a SIB via radio resource control (RRC) configuration.

19. The WTRU according to claim 16, wherein the at least one processor is configured to receive the configuration information in a SIB from a core network.

20. The WTRU according to claim 11, wherein the at least one processor is configured to determine that the PDCCH transmission is to be received using PCI hypotheses from a PCI hypothesis set, based on an indication comprised in the PBCH in the SSB.
